(19) United States
(12) Patent Application Publication
(10) Pub. No.: US 2007/0162588 A1
(43) Pub. Date: Jul. 12, 2007

(54) Method and system for adding group member

(75) Inventors: Xugang Wu, Shenzhen (CN); Zheng Wang, Shenzhen (CN); Yang Zhao, Shenzhen (CN)

Correspondence Address: Robert Popa;c/o LADAS & PARRY, Suite 2100, 5670 Wilshire Boulevard, Los Angeles, CA, 90036-5679, US

(73) Assignee: HUAWEI TECHNOLOGIES CO., LTD.

(21) Appl. No.: 11/699,867

(22) Filed: Jan. 30, 2007

Related U.S. Application Data
(63) Continuation of application No. PCT/CN06/02458, filed on Sep. 20, 2006.

(30) Foreign Application Priority Data
Sep. 26, 2005 (CN) 200510105026.3

(51) Int. Cl. G06F 15/173

(52) U.S. Cl. 709/223

(57) ABSTRACT

A method and a system for adding a group member, includes: sending a client corresponding to a user to be possibly added to a group a notification message to confirm whether the user agrees to be added to the group; obtaining a confirmation result from the client, and adding to the group the user who agrees to be added to the group. By utilizing the method and the system, unwanted disturbance caused by group management in a group communication system is lessened, meanwhile security of a group communication system is improved, and illegal spread of media which is harmful to individuals and society caused by flaws of a group system may be prevented.

### FIELD OF THE INVENTION

The present invention relates to communication technology, and particularly to a method and a system for adding a group member.

### BACKGROUND OF THE INVENTION

At present, in XDM(XML(Extensible Markup Language) Document Management) specifications of OMA(Open Mobile Alliance), a client may access an XDMS(XML Document Management Server) via an XDMC(XML Document Management Client) to create, modify, query and delete an XML document. The functions of an XDM engine will be described with an example of PoC (Push to Talk over Cellular) service.

The architecture of OMA-PoC in the conventional art is shown in FIG. 1. Client A creates a communication group on an XDMS via an XDMC of client A arranged in a LE(User Equipment). The communication group includes client B, client C and client D. The client B configures a black list on the XDMS via the XDMC of client B(arranged in a UE). The client A is included in the black list. The client A initiates a call to the PoC server with a group ID. The PoC server obtains the member list of the group according to the group ID from the XDMS, sends session requests to the members of the group according to the member list. Before the PoC server sends the session requests to the members of the group, the PoC server obtains the black list of the member from the XDMS, and sends the session requests to the client C and the client D. The client C and the client D accept the requests, start to communicate with the client A, while the PoC server examines that the client A is in the black list of the client B, and does not send a session request to the client B, thus the client B is not disturbed.

It may be seen from the above example that the XDM engine is a client-server system. The XDM engine provides service for other service engines, such as, PoC service, IM(Instant Message) service, etc., by providing some XML document management functions.

At present, in XDM specifications of OMA, the general process of generating and utilizing an XML document associated with a group is as follows:

(1) an administrator or a client creates a group in the server, adds associated members to the group. The server returns a group ID to the administrator or the client creating the group;

(2) the client who knows the group ID submits a service request to the server with the group ID. For example, in PoC service, the client sends session requests to the members of the group with the group ID; in IM service, the client sends instant messages to the members in the group with the group ID. Upon receiving the service request, the server obtains the group member list from the XDMS, sends the service request to the members according to the group member list.

In the conventional technical scheme, a user added to a group is passive during creating the group. The user may be added to a group without being negotiated with, thus the user suffers unwanted disturbance. Sometimes, the user of the group will be unhappy even if the user is not disturbed by services, such as, a certain user creates an illegal or unhealthy group and adds the user to the group while the user does not know.

### SUMMARY OF THE INVENTION

An embodiment of the present invention provides a method and a system for adding a group member.

The method for adding a group member includes:

receiving a request message for adding a group member from a PoC client, the request message comprising the PoC group information and information of a user to be possibly added to the PoC group;

obtaining the information of the user to be possibly added to the PoC group from the request message, and sending a confirmation message for confirming whether the user agrees to be added to the group to the client corresponding to the user to be possibly added to the PoC group;

obtaining the confirmation response information indicating agreeing to be added to the group;

adding the user corresponding to the confirmation response information to the group according to the group information in the request message.

The information of the users to be possibly added to the PoC group is a list of the users to be possibly added to the PoC group or a name of a sub-list of the users to be possibly added to the PoC group.

Obtaining the information of the user to be possibly added to the PoC group from the request message further includes: obtaining the information of the user to be possibly added to the PoC group according to the list of the users to be possibly added to the PoC group.

The group information is a group ID. Obtaining the information of the user to be possibly added to the PoC group from the request message further includes: obtaining the information of the user to be possibly added to the PoC group according to the group ID in the request message.

Adding the user corresponding to the confirmation response message to the group according to the group information in the request message further includes: preserving the information of the user corresponding to the confirmation response message in a group description file; or, setting the status identifier of the user corresponding to the confirmation response message as active.

An embodiment of the present invention provides an application server, including:

a member information obtaining module, used for receiving a request message sent from a client, obtaining a group ID in the request message, and obtaining information of users to be possibly added to the group from a group management server according to the group ID;

a notification message sending module, sending a user to be possibly added to the group a notification message to confirm whether the user agrees to be added to the group according to the obtained information of the users to be possibly added to the group An embodiment of the present invention provides an application server, including:

a group change notification subscribing module, subscribing to a group change notification from a group management server;

a group change notification receiving module, receiving the group change notification sent from the group management server, the group change notification comprising information of users whom a client intends to add to a group;

a notification message sending module, sending the user whom the client intends to add to the group a notification message for confirming whether the user agrees to be added to the group.

An embodiment of the present invention provides a group management server, including:

a client request receiving module, receiving a request message for adding a group member from a PoC client, the request message comprising the PoC group information and information of a user to be possibly added to the PoC group;

a notification message sending module, obtaining the information of the user to be possibly added to the PoC group from the request message, and sending a confirmation message for confirming whether the user agrees to be added to the group to the client corresponding to the user to be possibly added to the PoC group;

a group member management module, obtaining the confirmation response information indicating agreeing to be added to the group, adding the user corresponding to the confirmation response information to the group according to the group information in the request message.

The group management server further includes:

a group and group description file creating module, creating a group and generate a group description file according to the request message.

An embodiment of the present invention provides a communication system, including:

an application server, receiving a request message sent from a client, obtaining a group ID in the request message, and obtaining information of users to be possibly added to the group from a group management server according to the group ID, sending a user to be possibly added to the group a notification message to confirm whether the user agrees to be added to the group according to the obtained information of the users to be possibly added to the group;

a group management server, obtaining the confirmation response information indicating agreeing to be added to the group, and adding the user corresponding to the confirmation response information to the PoC group according to the group information in the request message.

According to an embodiment of the present invention, when adding a user to a group, a notification message is sent to the client corresponding to the user to be possibly added to the group to confirm whether the user agrees to be added to the group. The user may be added to the group only if the user confirms and agrees to be added to the group. Thus unwanted disturbance caused by group management in a group communication system is lessened, meanwhile security of a group communication system is improved. Illegal spread of media which is harmful to individuals and society caused by flaws of a group system can be prevented.

### BRIEF DESCRIPTION OF THE DRAWINGS

FIG. 1 is a diagram illustrating an architecture of OMA-PoC in the conventional art;

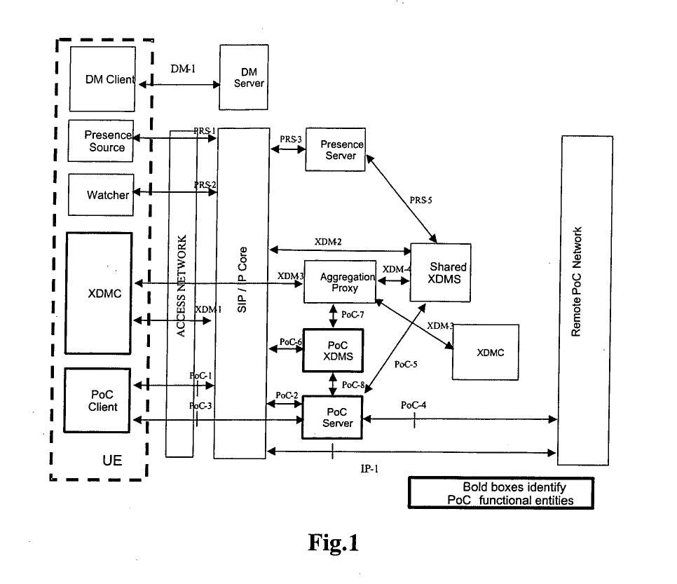

FIG. 2 is a flow chart of a method for adding a member to a group when creating a group according to an embodiment of the present invention;

FIG. 3 is a flow chart of a method for adding a member to a group when creating a group and notifying the member by an application server according to an embodiment of the present invention;

FIG. 4 is a flow chart of a method for adding a member to a group when creating a group and notifying the member by a group management server according to an embodiment of the present invention;

FIG. 5 is a flow chart of a method for adding a member to an existing group according to an embodiment of the present invention.

### DETAILED DESCRIPTION OF THE EMBODIMENTS

According to an embodiment of the present invention, in order to avoid disturbing a user, the user may be notified for confirmation when adding the user to a group, and only the user who agrees to be added to the group may be added to the group. A user may be added to a group when creating the group. A user also may be added to an existing group.

A group management server may send a notification message to a client corresponding to a user to be possibly added to the group. At this time, a notification function, such as short message notification function and/or mail notification function, etc., is added in the group management server on the basis of existing protocols.

An application server may also perform the notification function without changing the existing protocols of a group management server as far as possible. When creating a group and adding a member to the group, after the client receives a response of successful creation, the client sends a request to the application server, and the application server sends a notification message to the-client corresponding to the user to be possibly added to the group. When adding a member to an existing group, the client which requests for adding a member may send a request to the application server, and the application server sends a notification message to the client corresponding to the user to be possibly added to the group Or, the application server subscribes to status of a group description file from the group management server, and the application server is notified when the group management server adds a member, and the application server sends a notification message to the client corresponding to the user to be possibly added to the group.

The notification message contains information, such as, a group identifier, a group name, a creator and default status of no response (showing “agree” or “deny”), etc..

The user who agrees to be added to the group is added to the group in two ways:

(1) Only the information of the user who agrees to be added is preserved in the group description file. The information of the user who denies to be added will be deleted. It is defaulted that a user who does not respond denies to be added to the group. The user who does not respond may be notified before the information of the user is deleted. If the user who did not respond still does not respond, the information of the user will be deleted. Or, it may be defaulted that the user who does not respond agrees to be added to the group.

(2) Both the information of the user who agrees to be added to the group and the information of the user who denies to be added to the group are preserved in the group description file. A field ID identifying whether the user agrees to be added to the group is set in the description file. The status of the user is identified as active status if the user agrees to be added to the group, and the status of the user is identified as inactive status if the user denies to be added to the group or does not respond. The right to modify the field only belongs to the user to be possibly added to the group.

According to an embodiment of the present invention, the communication system includes an application server and a group management server, and further includes a notification message sending module arranged in the application server or the group management server. The notification message sending module sends the client corresponding to the user to be possibly added to the group a notification message to confirm whether the user agrees to be added to the group.

If the notification message sending module is arranged in the application server, the application server further includes:

a member message obtaining module, which receives a request message sent from a client, obtains a group ID in the request message and obtains information of group members from a group management server according to the group ID;

The notification message sending module is designed to send a client corresponding to a user to be possibly added to the group a notification message to confirm whether the user agrees to be added to the group according to the obtained information of group members.

If the notification message sending module is arranged in the application server, the application server farther includes:

a group change notification subscribing module, which subscribes to a group change notification from the group management server;

a group change notification receiving module, which receives the group change notification sent from the group management server. The group change notification includes information of a user whom a client intends to add to a group;

The notification message sending module is designed to send the user whom a client intends to add to a group a notification message to confirm whether the user agrees to be added to the group.

If the notification message sending module is arranged in the group management server, the group management server further includes:

a client request receiving module, which receives a request message for creating a group and adding a member to a group and/or a request message for adding a member to a specified group;

a group and group description file creating module, which creates a group and generates a group description file upon receiving the request message for creating the group and adding a member to the group;

a group member management module, which obtains a confirmation result from the user, and adds to the specified group the user who agrees to be added to the group.

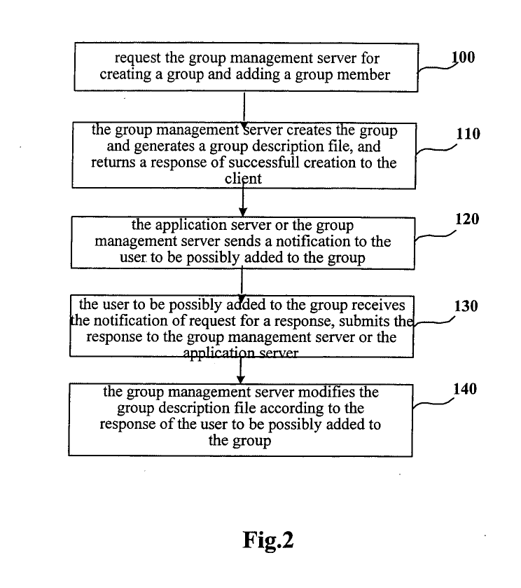

As shown in FIG. 2, the process for adding a member to a group when creating a group is as follows:

Process 100. a user submits a request message for creating a group and adding a member to the group to a group management server via a client.

Information of the user to be possibly added to the group submitted in the request message by the client may be a list of the users to be possibly added to the PoC group or a name of a sub-list of the users to be possibly added to the PoC group.

Process 110. the group management server creates the group and generates the group description file according to the request message for creating a group and adding a member to the group, and returns a response of successful creation to the client.

The description file may be in XML format, or a database. The creator of the group may query information of the group from the group description file according to the group ID. The group ID may be generated by the group management server, or be specified by the client.

The group description file may contain some additional information for group management of the group, such as, whether a group confirming process has started. The group description file may contain a field describing whether a group member is at active status. The right to modify the field only belongs to the user to be possibly added to the group. The default value of the field is inactive when creating a group.

Process 120. the application server or the group management server sends a notification message to the client corresponding to the user to be possibly added to the group, and requires the client to respond whether the user agrees to be added to the group.

Process 130. the client corresponding to the user to be possibly added to the group receives the notification message of the request for response, submits a response to the group management server or the application server.

Process 140. the group management server modifies the group description file according to the response from the client corresponding to the user to be possibly added to the group, or the application server notifies the group management server of the response from the client corresponding to the user to be possibly added to the group, and the group management server modifies the group description file according to the response.

The process for adding a member to an existing group is similar to the above before the process 120, the client sends a request for adding a member to the group to the group management server.

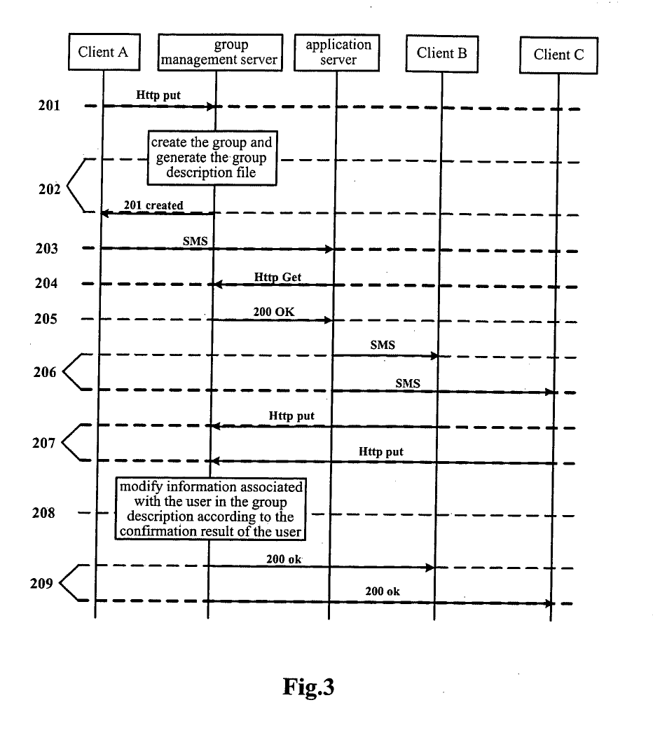

As shown in FIG. 3, a process of an embodiment for creating a group is as follows:

process 201. client A sends a group creating request to a group management server by means of HTTP protocol. The group creating request contains XML description of group information.

Process 202. the group management server creates a group and generates a group description file according to the group creating request from the client A, and returns a message of successful creation to the client A.

Process 203. the client A sends a request message to the application server for sending a message to a client corresponding to a user to be possibly added to the group to request a confirmation from the client corresponding to the user to be possibly added to the group. Parameters of the message include a group ID. The message may be sent by means of SIP protocol or other protocols.

Process 204. the application server queries information of the group members from the group management server according to the group ID.

In Process 203, upon receiving the request sent from-the client A, the application server may determine whether to start the group confirming process according to additional management information in the group description file. For example, if the group confirming process has already been started (that is, the application server have sent a confirmation message to the client corresponding to the user to be possibly added to the group), the application server will not start the group confirming process again(that is, the application server will not send the confirmation message to the client corresponding to the user to be possibly added to the group); or the group confirming process will not be started again after the application server has started the group confirming process for several times.

Process 205. the group management server returns information of the user to be possibly added to the group to the application server. The returned information may be described in XML.

Process 206. the application server sends the confirmation messages to client B and client C which are the clients corresponding to the users to be possibly added to the group. The latest client corresponding to the user to be possibly added to the group may receive the confirmation message.

Process 207. the client B and client C return the information for confirming whether they agree to be added to the group to the group management server.

Process 208. the group management server modifies information associated with the members in the group description file according to the confirmation results of the users(that is, information for confirming whether they agree to be added to the group from the client B and client C).

Process 209. the group management server returns a modification response message to the client B and client C.

The process 207 is started by the notification message described above, and also may be started by the user to be possibly added to the group.

If the group description file contains a field describing whether the group member is active, the group management server may modify the field describing whether the group member is active according to a request of the group member. If the group member wants to temporarily quit from the group or temporarily does not receive information or a communication invitation from the group, the group member also may directly or indirectly send a request to the group management server via the client of the group member by means of HTTP (HyperText Transfer Protocol) or XCAP(XML Configuration Access Protocol) protocol, and modify the field describing whether the group member is active.

The application server conforms with the following principles when using the group description file:

If in the confirming process, users who do not agree to be added to the group may also receive the notification messages, other processes other than the confirming process only have effect on users who have already agreed to be added to the group.

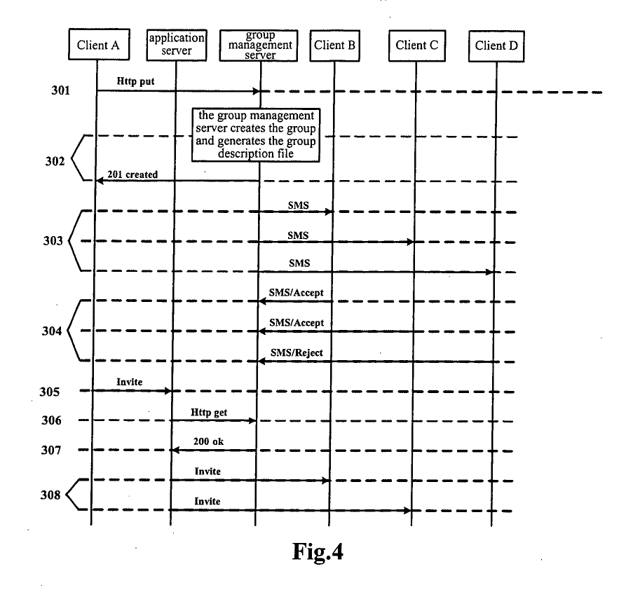

As shown in FIG. 4, the process of notifying users by a group management server and starting a session is as follows:

Process 301. client A sends a group creating request to a group management server by means of HTTP protocol. The group creating request contains XML description of group information.

Process 302. the group management server creates a group and generates a group description file, and returns a message of successful creation to the client A.

Process 303. the group management server sends a confirmation message to the clients corresponding to the users to be possibly added to the group (i.e., client B, client C and client D )to notify the users to confirm whether they agree to be added to the group.

Process 304. client B and client C return a message for agreeing to be added to the group to the group management server, and client D returns a message for denying to be added to the group to the group management server.

Process 305. the client A sends a session invitation carrying the group ID to the application server.

Process 306. the application server sends a message for obtaining information of the group members to the group management server.

Process 307. the group management server returns information of the group members to the application server.

Process 308. the application server sends session invitations to the client B and the client C.

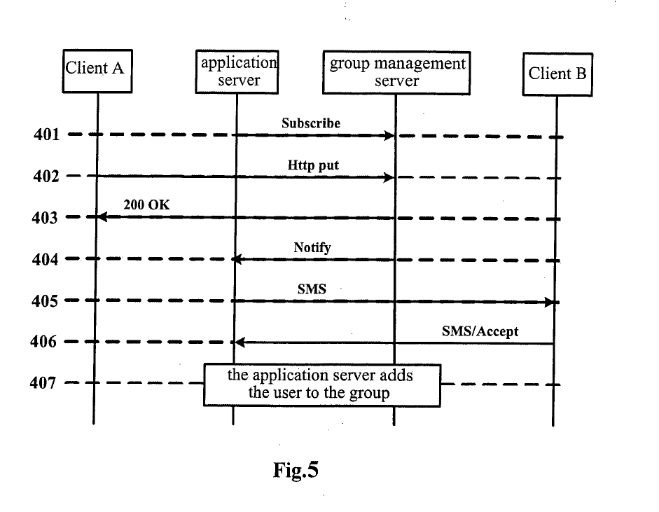

As shown in FIG. 5, a process for adding a member to an existing group, notifying a application server by a group management server, and notifying a client corresponding to a user to be possibly added to the group by the application server, is as follows:

Process 401. the application server subscribes to a group change notification from the group management server;

Process 402. client A sends a request for adding client B to the group to the group management server;

Process 403. the group management server successfully processes the request, and returns information to the client A;

Process 404. the group management server sends a group change notification to the application server;

Process 405. the application server sends a confirmation message to the client B, and requires the client B to confirm whether the client B agrees to be added to the group;

Process 406. the client B returns a message for agreeing to be added to the group to the application server;

Process 407. the application server notifies the group management server, the group management server adds the client B to the group by means of HTTP modification mode.

In the above embodiments, only notifying a client by means of message is described. A client may also be notified by means of mail or SIP message.

Apparently, those skilled in the art may make various variations and modifications to the present invention without departing from the spirit and scope of the present invention. Thus, if these variations and modifications are within the scope of claims of the present invention and its equivalent, it is intended to contain these variations and modifications in the present invention.

1. A method for adding a group member, comprising:
receiving a request message for adding a group member from a PoC client, the request message including the PoC group information and information of a user to be possibly added to the PoC group;
obtaining the information of the user to be possibly added to the PoC group from the request message, and sending a confirmation message for confirming whether the user agrees to be added to the group to the client corresponding to the user to be possibly added to the PoC group;
obtaining the confirmation response information indicating agreeing to be added to the group;
adding the user corresponding to the confirmation response information to the group according to the group information in the request message.

2. The method of claim 1, wherein the information of the users to be possibly added to the PoC group is a list of the users to be possibly added to the PoC group or a name of a sub-list of the users to be possibly added to the PoC group.

3. The method of claim 2, wherein, obtaining the information of the user to be possibly added to the PoC group from the request message comprises
obtaining the information of the user to be possibly added to the PoC group according to the list of the users to be possibly added to the PoC group.

4. The method of claim 1, wherein, the group information is a group ID; obtaining the information of the user to be possibly added to the PoC group from the request message comprises:
obtaining the information of the user to be possibly added to the PoC group according to the group ID in the request message.

5. The method of claim 1, wherein, adding the user corresponding to the confirmation response message to the group according to the group information in the request message comprises:
preserving the information of the user corresponding to the confirmation response message in a group description file; or,
setting the status identifier of the user corresponding to the confirmation response message as active.

6. The method of claim 2, wherein, adding the user corresponding to the confirmation response message to the group according to the group information in the request message comprises:
preserving the information of the user corresponding to the confirmation response message in a group description file; or,
setting the status identifier of the user corresponding to the confirmation response message as active.

7. An application server, comprising:
a member information obtaining module, receiving a request message sent from a client, obtaining a group ID in the request message, and obtaining information of users to be possibly added to the group from a group management server according to the group ID;
a notification message sending module, sending a user to be possibly added to the group a notification message to confirm whether the user agrees to be added to the group according to the obtained information of the users to be possibly added to the group.

8. An application server, comprising:
a group change notification subscribing module, subscribing to a group change notification from a group management server;
a group change notification receiving module, receiving the group change notification sent from the group management server, the group change notification comprising information of users whom a client intends to add to a group;
a notification message sending module, sending the user whom the client intends to add to the group a notification message for confirming whether the user agrees to be added to the group.

9. A group management server, comprising
a client request receiving module, receiving a request message for adding a group member from a PoC client, the request message comprising the PoC group information and information of a user to be possibly added to the PoC group
a notification message sending module, obtaining the information of the user to be possibly added to the PoC group from the request message, and sending a confirmation message for confirming whether the user agrees to be added to the group to the client corresponding to the user to be possibly added to the PoC group;
a group member management module, obtaining the confirmation response information indicating agreeing to be added to the group, adding the user corresponding to the confirmation response information to the group according to the group information in the request message.

10. The group management server of claim 9, further comprising:
a group and group description file creating module, creating a group and generate a group description file according to the request message.

11. A communication system, comprising:
an application server, receiving a request message sent from a client, obtaining a group ID in the request message, and obtaining information of users to be possibly added to the group from a group management server according to the group ID, sending a user to be possibly added to the group a notification message to confirm whether the user agrees to be added to the group according to the obtained information of the users to be possibly added to the group;
a group management server, obtaining the confirmation response information indicating agreeing to be added to the group, and adding the user corresponding to the confirmation response information to the PoC group according to the group information in the request message.
